(19) United States
(12) Patent Application Publication
(10) Pub. No.: US 2026/0253815 A1
(43) Pub. Date: Aug. 27, 2026

(54) DUAL VENTING SYSTEM FOR ARC CHUTE PERFORMANCE ENHANCEMENT

(71) Applicant: EATON INTELLIGENT POWER LIMITED, Dublin 4 (IE)

(72) Inventors: Arthur James Jur, Cleveland, TN (US); Dallas Bostian, Cleveland, TN (US); Abhishek Rao, Pune (IN); Joe Denton Pardue, Cleveland, TN (US)

(73) Assignee: EATON INTELLIGENT POWER LIMITED, DUBLIN 4 (IE)

(21) Appl. No.: 19/059,611

(22) Filed: Feb. 21, 2025

(51) Int. Cl. H01H 9/34; H01H 9/02

(52) U.S. Cl. CPC H01H 9/342; H01H 9/02

(57) ABSTRACT

An electrical switching apparatus includes separable contacts including a fixed contact and a movable contact, and an arc chute assembly including a housing and a splitter plate assembly provided within the housing, wherein the housing includes a first wall having a contact travel opening, a second wall having a first venting opening and a top wall having a second venting opening, wherein the first venting opening is provided in a first plane and the second venting opening is provided in a second plane that is perpendicular to the first plane, and wherein the movable contact is received within the housing and the splitter plate assembly through the contact travel opening and is movable along and within the contact travel opening and the splitter plate assembly.

### FIELD OF THE INVENTION:

The disclosed concept relates generally to electrical switching apparatus and, more particularly, to electrical switching apparatus, such as circuit breakers, switches or switch disconnects. The disclosed concept also relates to arc chutes for electrical switching apparatus. The disclosed concept further relates to venting assemblies/provisions for arc chutes.

### BACKGROUND OF THE INVENTION:

Electrical switching apparatus, such as circuit breakers, switches or switch disconnects, provide protection for electrical systems from electrical fault conditions such as, for example, current overloads, short circuits, and abnormal level voltage conditions.

Circuit breakers, switches or switch disconnects, for example, typically include a set of stationary electrical contacts and a set of movable electrical contacts. The stationary and movable electrical contacts are in physical and electrical contact with one another when it is desired that the circuit breaker energize a power circuit. When it is desired to interrupt the power circuit, the movable contacts and stationary contacts are separated. Upon initial separation of the movable contacts away from the stationary contacts, an electrical arc is formed in the space between the contacts. The arc provides a means for smoothly transitioning from a closed circuit to an open circuit but produces a number of challenges to the circuit breaker or switch designer. Among them is the fact that the arc results in the undesirable flow of electrical current through the circuit breaker to the load. Therefore, it is desirable to extinguish any such arcs as soon as possible upon their propagation.

To facilitate this process, circuit breakers, switches or switch disconnects typically include arc chute assemblies that are structured to attract and break up the arcs. Specifically, the movable contacts of the circuit breaker are mounted on arms that are contained in a pivoting assembly that pivots the movable contacts past or through arc chutes as they move into and out of electrical contact with the stationary contacts. Each arc chute includes a plurality of spaced apart are splitters or arc plates mounted in a wrapper. As the movable contact is moved away from the stationary contact, the movable contact moves past the ends of the arc plates, with the arc being magnetically drawn toward and between the arc plates. The arc plates are electrically insulated from one another such that the arc is broken-up and extinguished by the arc plates. Examples of arc chutes are disclosed in U.S. Pat. Nos. 8,642,913; 7,034,242; 6,703,576; and 6,297,465.

Additionally, along with the generation of the arc itself, ionized gases are formed as a byproduct of the arcing event. Such gases can cause excessive heat, additional arcing, and internal pressure and, therefore, are harmful to electrical components. The ionized gases can undesirably cause the arc to bypass a number of intermediate arc plates as it moves through the arc chute. This reduces the number of arc voltage drops and the effectiveness of the arc chute. It also creates current and gas flow patterns that tend to collapse groups of arc plates together, further reducing the voltage divisions in the arc chute and its cooling effectiveness. Additionally, the internal pressure generated by this volume of gas can cause damage to the circuit breaker.

There is a need, therefore, room for improvement in electrical switching apparatus, such as circuit breakers, switches or switch disconnects, and in arc chutes and venting assemblies therefor.

### SUMMARY OF THE INVENTION:

These needs, and others, are met by an electrical switching apparatus, such as a circuit breaker, comprising separable contacts including a fixed contact and a movable contact, and an arc chute assembly including a housing and a splitter plate assembly provided within the housing, wherein the housing includes a first wall having a contact travel opening, a second wall having a first venting opening and a top wall having a second venting opening, wherein the first venting opening is provided in a first plane and the second venting opening is provided in a second plane that is perpendicular to the first plane, and wherein the movable contact is received within the housing and the splitter plate assembly through the contact travel opening and is movable along and within the contact travel opening and the splitter plate assembly.

### BRIEF DESCRIPTION OF THE DRAWINGS:

A full understanding of the invention can be gained from the following description of the preferred embodiments when read in conjunction with the accompanying drawings in which:

FIG. 1 is a schematic diagram, in partial cross section, of a circuit breaker assembly including an arc chute assembly according to an exemplary embodiment of the disclosed concept; and

FIG. 2 is a front isometric view, FIG. 3 is a rear isometric view, and FIG. 4 is an exploded view of the arc chute assembly of FIG. 1.

### DETAILED DESCRIPTION OF THE INVENTION:

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

This disclosed concept provides a system to effectively converge ionized gases inside a splitter plate grid assembly by employing two venting ports perpendicular to each other. The two-cooling port chamber increases the cooling effect of the hot ionized gases, improves arc extinction capability, and reduces the burning loss of the splitter plates, all of which inherently benefits the contact system of a switching device to achieve a higher voltage rating for low voltage switching in an air medium.

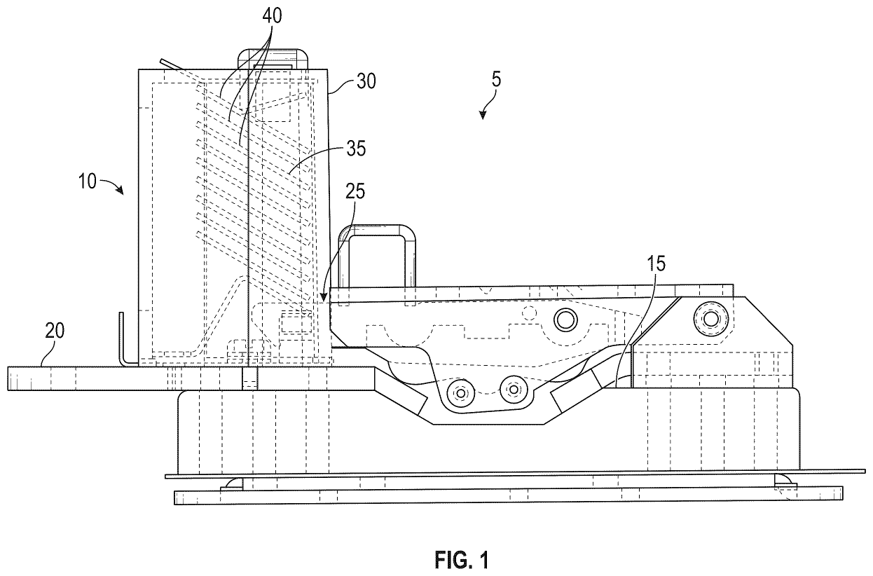

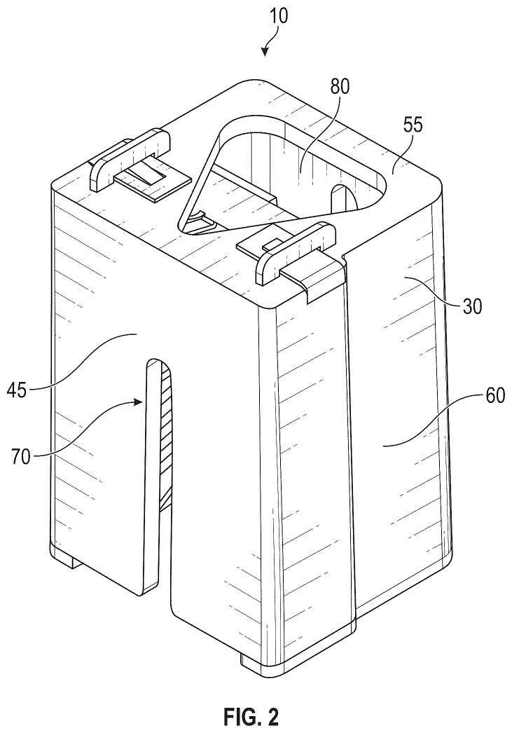

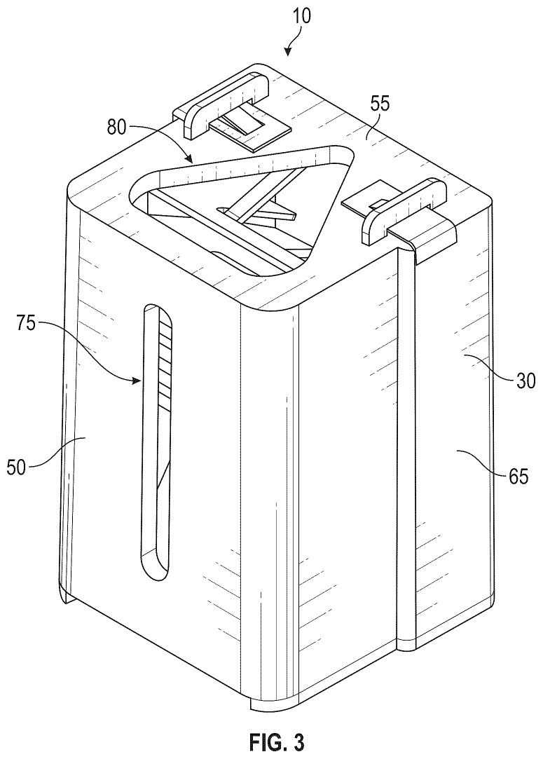

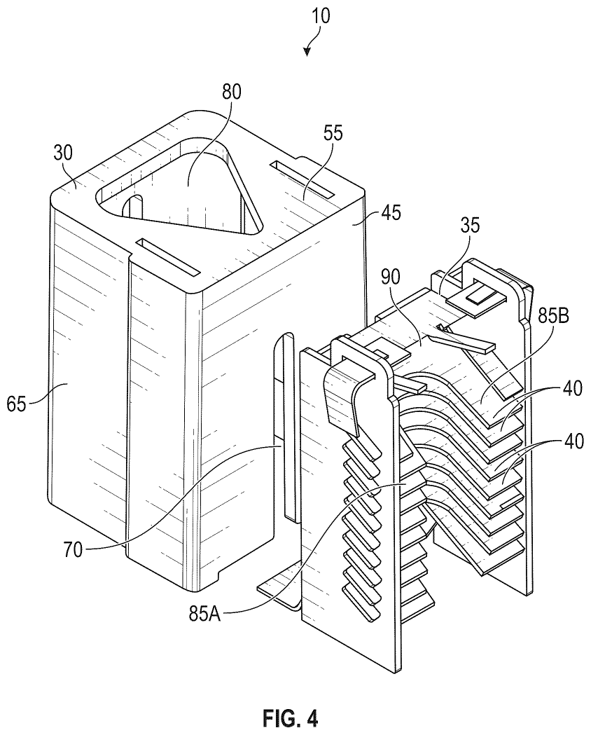

FIG. 1 is a schematic diagram, in partial cross section, of a circuit breaker assembly 5 including an arc chute assembly 10 according to an exemplary embodiment of the disclosed concept. FIG. 2 is a front isometric view, FIG. 3 is a rear isometric view, and FIG. 4 is an exploded view of arc chute assembly 10. Circuit breaker assembly 5 includes a switch base 15. As seen in FIG. 1, arc chute assembly 10 is provided and supported on a top surface of switch base 15. Switch base 15 supports a set of separable contacts including a fixed contact 20 and a movable contact 25 of circuit breaker assembly 5. Circuit breaker assembly 5 also includes an operating mechanism that is structured to open and close the separable contacts 20, 25 and to trip open the separable contacts 20, 25 in response to an electrical fault, such as an overcurrent condition.

Furthermore, as seen in FIGS. 1-4, arc chute assembly 10 includes an arc chute housing 30 and a splitter plate assembly 35 housed within arc chute housing 30. Splitter plate assembly 35 includes a plurality of U-shaped or Y-shaped splitter plates 40. As seen in FIG. 4, each splitter plate 40 includes first and second side arms 85A, 85B, and a base 90. As a result, each splitter plate 40 includes an open end positioned in between the first and second side arms 85A, 85B.

Arc chute housing 30 includes a front wall 45, a rear wall 50, a top wall 55, and side walls 60, 65. As seen in FIG. 2, front wall 45 includes an elongated contact travel opening 70. The movable contact 25 is received through and movable within and along contact travel opening 70. Splitter plates 40 are positioned within arc chute housing 30 in a manner where the open end of each splitter plate 40 faces and is adjacent to contact travel opening 70. As a result, when movable contact 25 is caused to move within and along contact travel opening 70, it is also able to move within each open end of the splitter plates 40. Rear wall 50 includes a first (elongated) venting opening 75, and top wall 55 includes a second (triangular-shaped) venting opening 80. First venting opening 75 is provided in a first plane and second venting opening 80 is provided in a second plane, wherein the first plane and the second plane are perpendicular to one another.

In operation, in response to a fault condition, the operating mechanism of circuit breaker assembly 5 will cause moveable contact 25 to separate and move away from fixed contact 25 within contact travel opening 70 and the open end of each splitter plate 40. During this travel, splitter plates 40 will attract and dissipate arcs that are formed between movable contact 25 and fixed contact 20. In addition, ionized gasses that are formed as a result of arcs will be converged inside splitter plate assembly 35, will be cooled within arc chute housing 10, and will be vented out of first and second perpendicularly oriented venting openings 75, 80. In particular, arch chute housing 10 with its two perpendicularly oriented venting openings 75 and 80 increases the cooling effect on the hot ionized gases by increasing the discharge flow of the hot ionized gases, improves arc extinction capability, reduces the burning loss of splitter plates 40, and improves the switching cycle of circuit breaker assembly 5, all of which advantageously allows circuit breaker assembly 10 to achieve a higher voltage rating for low voltage switching in an air medium.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An electrical switching apparatus, comprising:
separable contacts including a fixed contact and a movable contact; and
an arc chute assembly including a housing and a splitter plate assembly provided within the housing, wherein the housing includes a first wall having a contact travel opening, a second wall having a first venting opening and a top wall having a second venting opening, wherein the first venting opening is provided in a first plane and the second venting opening is provided in a second plane that is perpendicular to the first plane, and wherein the movable contact is received within the housing and the splitter plate assembly through the contact travel opening and is movable along and within the contact travel opening and the splitter plate assembly.

2. The electrical switching apparatus according to claim 1, wherein the electrical switching apparatus comprises a circuit breaker, switch or switch disconnect.

3. The electrical switching apparatus according to claim 1, wherein the first wall is a front wall of the housing and the second wall is a rear wall of the housing.

4. The electrical switching apparatus according to claim 1, wherein the first venting opening is an elongated opening extending along a longitudinal axis of the second wall.

5. The electrical switching apparatus according to claim 1, wherein the second venting opening is triangular-shaped opening.

6. The electrical switching apparatus according to claim 1, wherein the contact travel opening is an elongated opening extending along a longitudinal axis of the first wall.

7. The electrical switching apparatus according to claim 1, wherein the first wall is a front wall of the housing and the second wall is a rear wall of the housing, wherein the contact travel opening is an elongated opening extending along a longitudinal axis of the front wall, wherein the first venting opening is an elongated opening extending along a longitudinal axis of the rear wall, and wherein the second venting opening is triangular-shaped opening.

8. The electrical switching apparatus according to claim 7, wherein the splitter plate assembly includes a plurality of U-shaped or Y-shaped splitter plates, each splitter plate having an open end positioned adjacent to the contact travel opening.

9. The electrical switching apparatus according to claim 1, wherein the splitter plate assembly includes a plurality of U-shaped splitter plates, each splitter plate having an open end positioned adjacent to the contact travel opening.

10. The electrical switching apparatus according to claim 1, further comprising a switch base supporting the separate contacts, wherein the hosing is positioned on a top surface of the switch base.
